(19) United States
(12) Patent Application Publication
(10) Pub. No.: US 2004/0246174 A1
(43) Pub. Date: Dec. 9, 2004

(54) Antenna system for links between mobile vehicles and airborne devices

(76) Inventors: Frederic Lamour, Sartrouville (FR); Pierre-Henri Boutigny, Melun (FR); Maurice Elkael, Le Vesinet (FR); Ivan Wolk, Arnouville Les Gonesse (FR)

Correspondence Address: LOWE HAUPTMAN GILMAN & BERNER, LLP, 1700 DIAGNOSTIC ROAD, SUITE 300, ALEXANDRIA, VA, 22314, US

(21) Appl. No.: 10/365,622

(22) Filed: Feb. 13, 2003

(51) Int. Cl. H04B 7/10

(52) U.S. Cl. 342/361

(57) ABSTRACT

An antenna system enabling a link between an airborne object sending out a signal E with any polarization and a moving body equipped with a dual-polarization antenna comprises at least one device to determine the position of the moving body and of the airborne object, and an assembly for positioning the antenna. The system comprises at least one polarization combiner receiving two signals H and V coming from the dual-polarization antenna, the signals H and V resulting from the signal coming from the airborne object; the combiner being adapted to recombining the signals H and V in order to obtain a signal E optimizing the link balance between the moving body and the airborne object.

### BACKGROUND OF THE INVENTION

1. Field of the Invention

The invention relates to the field of antennas used, especially, to set up links between a mobile craft and an airborne device, these two objects having low-speed shifts and movements.

In the context of satellite telecommunications systems, or more generally for communications with airborne or celestial objects, these systems are increasingly installed in mobile craft such as aircraft or motor-driven vehicles (for example for television reception, high-bit-rate satellite communications, etc.).

These systems generally require high-gain antennas which must be carefully aimed at the object in order to ensure acceptable reception quality.

Two problems then arise:

1—the integration of high-gain antennas which require a relatively large amount of space, in moving vehicles (entailing problems of discretion and aerodynamics),

2—the aiming which varies as a function of possible movements of the vehicle on which the antenna is installed and in which there may be a deterioration in the quality of the link, or even a breaking of the link.

2. Description of the Prior Art

The prior art proposes especially three types of solution explained here below.

The first is that of mechanical deflection along two axes. This is the most commonly used approach. It consists of the use of a fixed-beam directional antenna, coupled with a two-axis (generally elevation/azimuth) positioner. The antennas used are generally parabolas or radiating slot arrays with waveguide distribution systems. These antennas have very high performance in terms of gain.

The advantages of this approach are that it offers constant RF performance whatever the deflection and an almost total coverage of space. Its drawbacks are related especially to the use of a two-axis positioner, namely:

substantial purchase and maintenance costs with moderate reliability especially in aircraft,

difficulty of integration, because the antenna has to be unencumbered in its movements so that it can be accurately aimed (this entails problems of aerodynamics for aircraft and discretion for land-based vehicles),

sensitivity to vibrations and impacts (entailing severe constraints on the mechanical system which lead to high costs).

The second approach relies on an electronic two-axis method of deflection. In this case, the antenna is generally flat and consists of an array of elementary radiating elements. Each element has an associated electronic module by which it is possible to obtain variations in phase and, if necessary, in amplitude, so as to generate a beam in both axes of the plane of the antenna with a certain side-lobe level. Several variants exist for this type of antenna: these are, for example, active module antennas, reflect-array antennas, transmit-array antennas, etc. This approach has very high precision and great aiming speed. However, it has certain drawbacks:

the radioelectrical performance deteriorates rapidly with the angle of deflection of the beam (drop in gain, rise in lobe level, etc),

the solutions are costly because there are as many electronic modules as there are elementary radiating elements with commands and complex associated processing operations,

the antenna can cover only a defined portion of space (a maximum of one half plane) unless it is combined with a one-axis positioner (for example in the case of radars). The costs then accumulate and become very high, and even prohibitive in the case of connections for amenities, for example for television reception.

The third approach is an intermediate approach combining 1D mechanical deflection and 1D electrical deflection. A mechanical one-axis deflection is combined with an electrical one-axis deflection. In this way, a mechanical approach which is simpler and less costly than the first approach, is combined with an electrical approach (using n instead of n² electronic modules) that is simpler than the one described in the second approach. This third approach offers greater reliability because the mechanical constraints are reduced. It also entails reasonable cost because the system is mechanically less complex than a 2D mechanical deflection system and radioelectrically less complex than a 2D electrical deflection system. However, it leads a decrease in performance as a function of the deflection. Furthermore, the coverage of space is highly dependent on the performance of the antenna in terms of deflection (the maximum angle of deflection ensuring efficient performance).

### SUMMARY OF THE INVENTION

The idea of the invention is based especially on a judicious combination using 1D electrical deflection and 1D mechanical deflection.

The invention relates to an antenna system enabling a link between an airborne object sending out a signal with any polarization and a moving body equipped with a dual-polarization antenna, comprising at least one device to determine the position of the moving body and the airborne object and an assembly for positioning the antenna. The system comprises at least:

one polarization combiner receiving two signals H and V coming from the dual-polarization antenna, the signals H and V resulting from the signal coming from the airborne object,

the polarization combiner being adapted to recombining the signals H and V in order to obtain a signal E optimizing the link balance between the moving body and the airborne object.

The positioning assembly comprises, for example, at least one mechanical positioner linked with the antenna, a control unit to control the phase-shifters of the antenna and an antenna deflection device. The antenna has, for example, a circular or rectangular shape and

is mounted on a one-axis positioner.

The invention also relates to a method to optimize the link balance between a dual-polarization antenna associated with a moving body and an airborne object sending out a signal E with any polarization. It comprises at least following steps:

determining the positions of the mobile body and of the airborne object,

from the value of said positions, positioning the antenna mechanically and electronically,

transmitting the two signals H and V coming from the antenna towards a combination step adapted to the production of a signal E corresponding to an optimum link balance between the moving body and the airborne object,

diverting a part of this signal and comparing it with a threshold.

It may also comprises a step in which the value of the amplitude of the diverted signal is compared with a threshold value and a step in which the antenna is repositioned if the value of the amplitude is below a given value.

The deflection system according to the invention has the following advantages in particular:

mechanical deflection that is feasible and robust, at reasonable cost and with fair reliability,

an approach enabling discreet integration,

real-time optimization of the link balances between the mobile vehicle and the airborne object,

the calibration of the antenna is made unnecessary, thus making the cost of the system affordable,

flexibility of the configuration of the output channels, with the possibility of several types of combiners.

### BRIEF DESCRIPTION OF THE DRAWINGS

Other features and advantages of the invention shall appear more clearly from the following description, given by way of an illustration that in no way restricts the scope of the invention and made with reference to the appended figures, of which:

FIG. 1 is a schematic diagram of the deflection system according to the invention,

FIG. 2 is a flow chart of the different steps implemented,

FIG. 3 is a schematic diagram of the 1D electrical deflection system,

FIG. 4 is a drawing explaining the association of 1D mechanical deflection with 1D electrical deflection,

FIG. 5 shows an alternative embodiment of FIG. 4,

FIGS. 6 and 7 are two illustrations showing the utility of the dual-polarization system used,

FIG. 8 shows a first exemplary analog polarization combiner,

FIG. 9 shows a second exemplary digital polarization combiner,

FIGS. 10 and 11 show two examples of the installation of the system according to the invention on mobile vehicles.

### MORE DETAILED DESCRIPTION

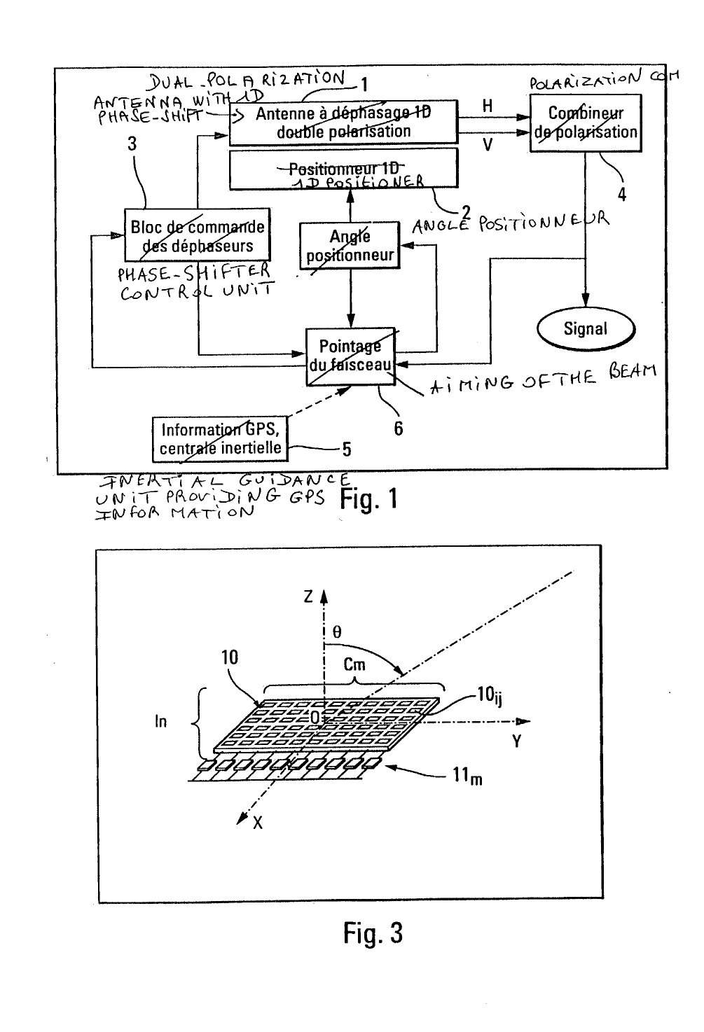

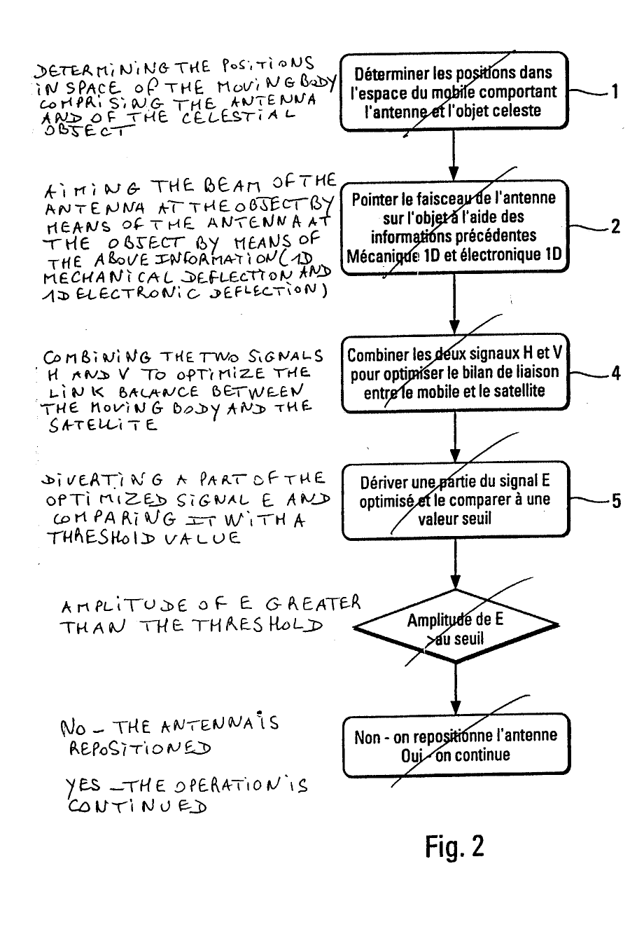

The system according to the invention is shown, for example, by means of the schematic diagram of FIG. 1 where the antenna is mounted, for example, on a mobile vehicle in communication with a satellite which is not shown for reasons of clarity. The satellite sends out a signal with any polarization.

The system comprises a dual-polarization antenna 1 with a 1D phase-shift. This antenna 1 is linked with a 1D mechanical positioner 2 whose role is to position the antenna mechanically. The mechanical positioner is, for example, a shaft associated with a motor with a gear mechanism by which the antenna can be rotated and placed in a desired position. A control unit 3 for the control of the phase shifters 11ₘ of the antenna (FIG. 3) is used to vary the phase of the different antenna elements. A polarization combiner 4 has the function especially of combining the two signals H and V obtained at the two output channels of the antenna 1 (corresponding to a division of the signal received by the dual-polarization antenna into two orthogonal or substantially orthogonal axes). The combiner 4 is adapted to obtaining an optimized link balance between the mobile vehicle and the satellite by recombining the signals H and V. An inertial guidance unit 5 is used to obtain GPS positioning information from the satellite and from the mobile vehicle for example. Their x, y, z coordinates are therefore placed in a 3D system of coordinates. A beam-deflection or beam-aiming device 6 receives at least one part of the signal coming from the polarization combiner as well as the position information (for example the coordinates of the satellite and of the mobile vehicle in a 3D system of coordinates, the value of the angle of the positioner, the value of the phase-shifters). The function of this deflection device especially is to enable the aiming of the beam from the antenna to the satellite in real time. It enables especially automatic compensation for the motion of the satellite or of the moving object to aim the beam.

The steps of the method implemented are, for example, the following:

1—Collecting information on the position of the satellite and the mobile vehicle equipped with the antenna, for example by means of the inertial guidance unit,

2—Transmitting this GPS information to the beam-aiming device which acts on the positioner and the commands of the phase-shifters to:

aim the beam from the antenna to the satellite (mechanical deflection),

control the phase-shifters (electronic deflection), so that the antenna is aimed at the satellite,

3—since the polarization of the signal sent by the satellite is any polarization, the antenna receives this signal and breaks it down into two signals H and V having orthogonal or substantially orthogonal polarizations,

4—transmitting these two signals H and V to the polarization combiner 4 which combines them in such a way that the link balance between the antenna and the satellite is optimized. The combination is achieved, for example, by optimizing the link balance: one criterion could be the value of the signal-to-noise ratio,

5—transmitting at least a part of this optimized signal to the beam-aiming device. This device compares, for example, the amplitude of the signal with a threshold level fixed beforehand in order to verify the state of the link between the two objects. Any other parameter representing the state of the link can be used as a threshold value. To pick up a part of the output signal from the combiner, the invention uses, for example, a directional coupler to send it to the deflection system and obtain a real-time aim correction, for example.

The antenna 10 (FIG. 3) is for example a dual-polarization, plane antenna that can be electrically deflected along an axis by the commands of the phase-shifters 11ₘ.

FIG. 3 shows the principle of the 1D electrical deflection. In this example, the antenna is deflected along the plane Oyz in the direction of the lines of the array between [−θmax, +θmax]. The maximum angle is defined by a minimum gain or a lobe level to be ensured.

The antenna 10 takes the form of a plane array of radiating elements 10ₙₘ distributed in the form of n lines In and m columns Cm. Each column is connected, for example, to an electronic module (phase-shifter) 11ₘ used to vary the phase of each of the radiating elements 10ₙₘ. In this example, m electronic modules are used to phase-shift the elements, as compared with n*m elements for a two-axis or 2D electrical phase-shift. This considerably simplifies the electronics.

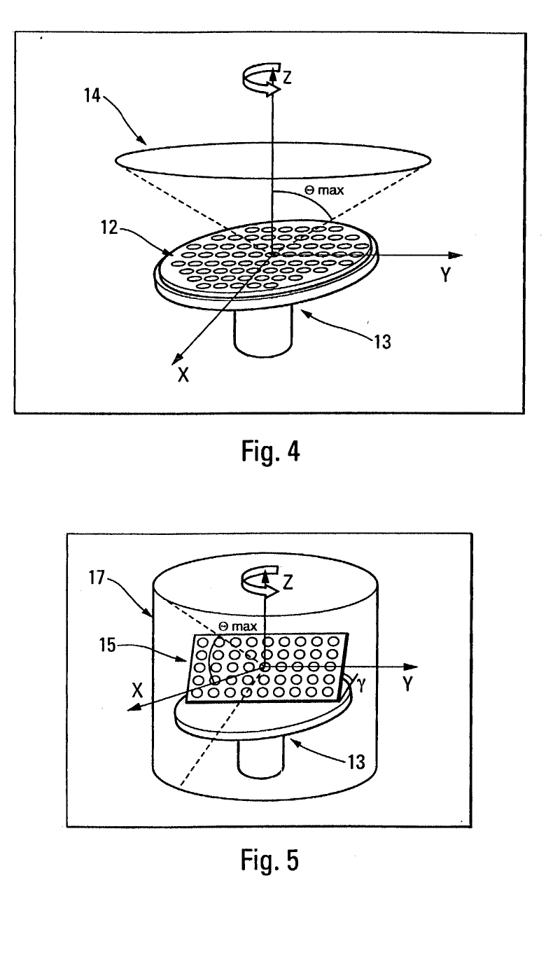

FIG. 4 gives a schematic view of the association between a 1D mechanical deflection system and a 1D electrical deflection system.

The electronic deflection antenna 12, shown by way of an example, is positioned flat on a one-axis positioner 13. The center of this positioner coincides with the phase center of the currents and the center of inertia of the antenna. The antenna is generally homogeneous. The antenna is circular or substantially circular in shape and has n lines and m columns. The number of columns differs as a function of the position of the line.

Making the positioner 13 rotate 360° on its axis enables the antenna to illuminate a cone 14 with an angle θmax. Thus a 2D scan is recreated.

In this way, the constraints on the positioner are far less stringent than in the case of an antenna with two-axis mechanical deflection, especially as the plane antenna, in general, is relatively light and homogeneous with a substantial bearing surface on the positioner.

This makes it possible to have a 2D deflection system at an attractive cost and with high reliability. The constraints on the mechanical part are light and the electronic commands are relatively small in number.

FIG. 5 shows a variant better suited to covering the grazing angles, provided that the antenna has small dimensions so as not to impose major constraints on the positioner.

The 1D electronic deflection antenna 15 is a rectangular array of radiating elements 15ₙₘ comprising n lines and m columns. The plane of the antenna forms a given angle γ with the plane of the positioner. The illumination cone obtained by the rotational motion is referenced 17.

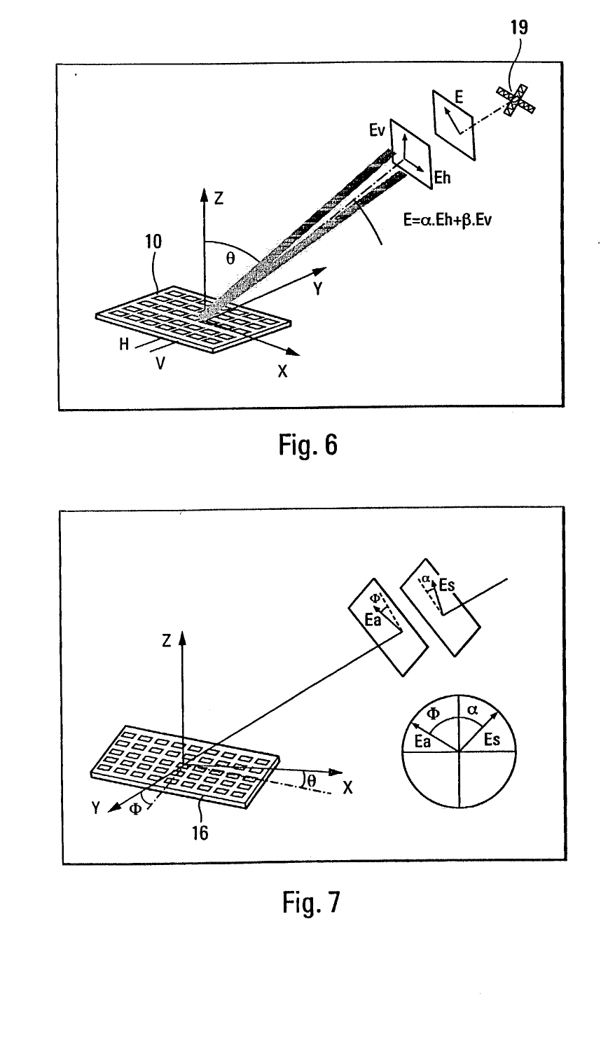

FIG. 6 gives a schematic view of the two orthogonal polarizations Ev and Eh (coming from the dual-polarization antenna which gives the signals H and V) obtained at the two outputs of the antenna. Linearly combining the two polarizations in the polarization combiner, according to a given algorithm, then makes it possible to describe the entire polarization plane or at least the major part of it.

This linear combination is given by the following relationship:

E=αEh+βEv (α, β complex values)

The idea is to recombine these values Ev and Eh to obtain the polarization of the signal sent by the satellite 19.

This system is well suited to mobile vehicles that are linked with or are to be linked with satellites or slow-moving airborne devices which can transmit, without distinction, in vertical linear, horizontal linear, right circular, left circular or even elliptical polarization.

FIG. 7 gives a schematic view of the method of compensating for the inclination of the mobile vehicle on which the antenna is positioned or the inclination of the polarization plane of the satellite or of the airborne object in the case of linear polarization links. If there is no compensation, there is a risk of deterioration of the link or even of the breaking of the link.

In this example, the polarization plane Ea of an antenna 16 placed on a vehicle (which has not been shown for the sake of simplification) is inclined by an angle φ to the vertical and by an angle θ to the horizontal. The polarization plane Es of the satellite signal is inclined by an angle α to the vertical. The two polarization planes form an angle φ+α with each other. This gives rise to depolarization losses and may lead to an absence or loss of a link, if the sum of the angles φ+α is equal to 90°.

The polarization combiner then carries out a processing operation on each channel H and V in order to achieve the real-time re-creation of the vector Es corresponding to the polarization vector sent out by the satellite. The link balance between the mobile vehicle and the satellite is thus optimized.

In addition to ensuring link balances that are stable or substantially stable when the vehicle is inclined and when the satellite (or airborne object) is in the illumination cone, this system enables the simultaneous reception of two orthogonal (or substantially orthogonal) polarizations for each signal processing operation on different sub-channels.

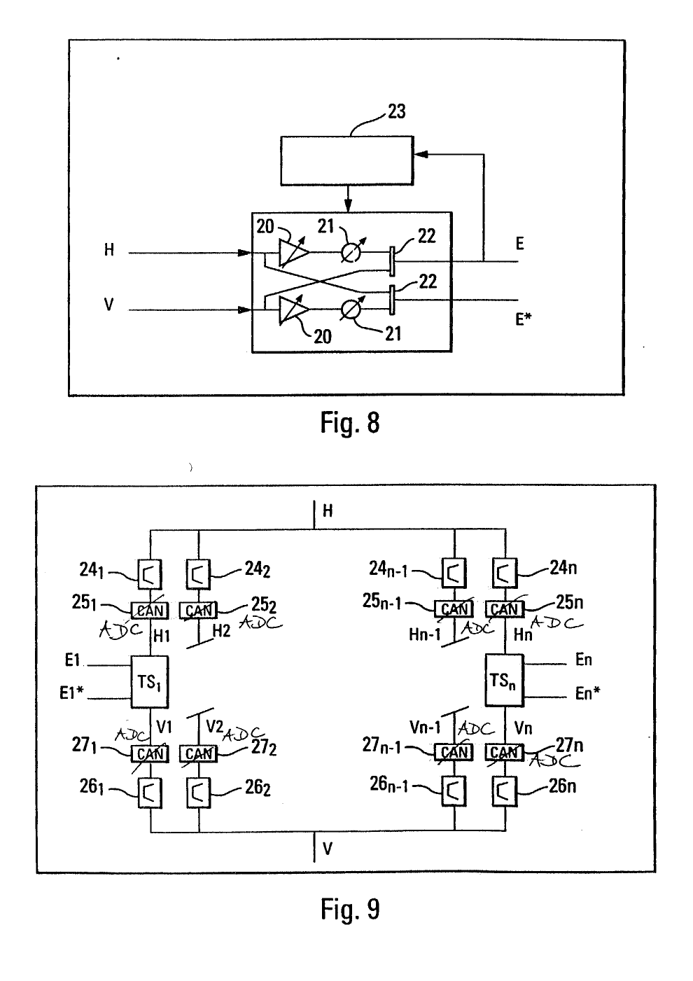

The processing of the channels H and V is obtained, for example, by means of a polarization combiner, two exemplary embodiments of which are given in FIGS. 8 and 9.

The combiner is a processing device adapted to the real-time optimizing of the link balance between the mobile vehicle and the satellite. It adjusts the amplitude and phase coefficients of a classic combiner.

FIG. 8 shows an analog type combiner. According to the drawing, two signals H and V coming from the antenna are sent to the polarization combiner. The combiner has a part comprising two parallel channels, each comprising an amplifier 20 followed by a phase-shifter 21 and an adder 22. The two channels produce a signal E equal to V+ae^{jΦ}H and a complementary signal E* equal to H+be^{jτ}V. The signal E is then sent on to the processing unit 23. This unit has the function especially of verifying that the combined signal E is optimal, for example by comparing the value of the signal-to-rise ratio with a threshold value. Any other parameter representing the link balance may be used to seek the optimum system. The signal E is sent to the processing device until an optimum value, corresponding to an optimum link balance, is found.

This procedure offers especially the following advantages:

It removes the need for a painstaking and costly calibration of the assembly formed by the antenna, the channels H and V plus the polarization combiner,

It provides the capability to synthesize any polarization whatsoever and, consequently, there is theoretically no deterioration of the link when the vehicle or the polarization plane of the airborne object is inclined.

This solution using the analog polarization combiner is effective on a relatively narrow band because the coefficients applied are valid for the entire signal band and necessitate an analog-digital and digital-analog conversion that cannot easily be achieved in the present state of the prior art on relatively narrow bands.

According to another variant given in FIG. 9, it is possible to extend this approach to a given number of sub-channels by digitizing the signal on each sub-channel by filtering. The system makes it possible to provide 2*n signals simultaneously and a single analog-digital conversion per channel is sufficient.

The signal H is divided into two n sub-channels 24i by means of adapted filters linked to an ADC referenced 25i. The ADCs referenced 25i are connected to the signal-processing device TSi.

The signal V is itself sub-divided into n sub-channels 26i and into n ADCs referenced 27i. The different sub-signals are then transmitted to the signal-processing device TSi.

The number of signal-processing devices TSi is equal to half the number of sub-channels for example, it being known that the signal Hi and a signal Vi are transmitted to the same signal-processing device TSi in order to produce an optimum signal Ei.

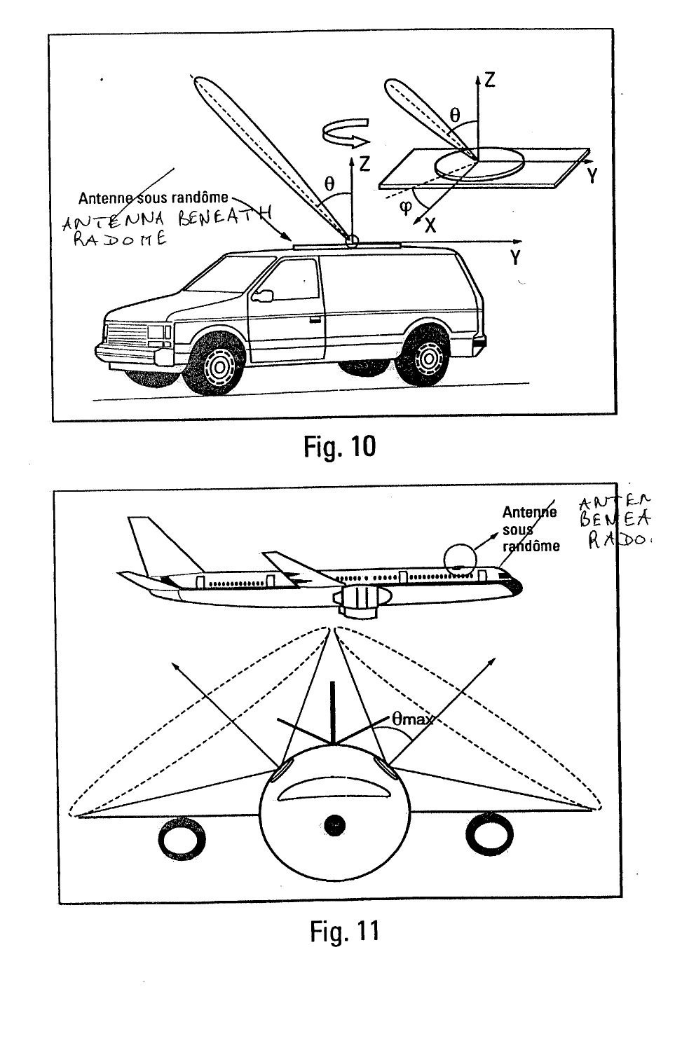

FIG. 10 shows a system according to the invention installed on an automobile vehicle which is linked with a satellite for example.

FIG. 11 shows a variant in which two systems according to the invention are positioned on either side of an aircraft. The aircraft is linked with a satellite or another aircraft or again a celestial object, the shifting and the movements of each of these bodies being sufficiently slow.

The description has been given by way of a non-exhaustive illustration in the case of a link between an antenna positioned on a mobile vehicle and a satellite.

It can be applied in the case of links between antennas and an airborne object or a geostationary celestial object or, again, a slow-moving object.

1. An antenna system enabling a link between an airborne object sending out a signal with any polarization and a moving body equipped with a dual-polarization antenna, comprising at least one device to determine the position of the moving body and of the airborne object, and an assembly for positioning the antenna, wherein the system comprises:
one polarization combiner receiving two signals H and V coming from the dual-polarization antenna, the signals H and V resulting from the signal coming from the airborne object;
the polarization combiner being adapted to recombining the signals H and V in order to obtain a signal E optimizing the link balance between the moving body and the airborne object.

2. The system according to claim 1 wherein the positioning assembly comprises one mechanical positioner linked with the antenna, a control unit to control the phase-shifters of the antenna and an antenna deflection device.

3. The system according to claim 1 wherein the antenna has a circular or rectangular shape and is mounted on a one-axis positioner.

4. The system according to claim 1 wherein the combiner is an analog type combiner.

5. The system according to claim 1 wherein the combiner is of a digital type and wherein each signal is divided into several sub-channels.

6. A method to optimize the link balance between a dual-polarization antenna associated with a moving body and an airborne object sending out a signal E with any polarization, wherein the method comprises the following steps:
determining the positions of the mobile body and of the airborne object;
from the value of said positions, positioning the antenna mechanically and electronically;
transmitting the two signals H and V coming from the antenna towards a combination step adapted to the production of a signal E corresponding to an optimum link balance between the moving body and the airborne object;
diverting a part of this signal and comparing it with a threshold.

7. The method according to claim 6, wherein the value of the amplitude of the diverted signal is compared with a threshold value and a step in which the antenna is repositioned if the value of the amplitude is below a given value.

8. The method according to claim 8, wherein the method is usable for an automobile vehicle linked with a satellite or an aircraft linked with another aircraft or a satellite.

9. The system according to claim 1, wherein the antenna system is used with an automobile linked with one of a satellite or an aircraft linked with another aircraft or a satellite.
